(19) United States
(12) Patent Application Publication
(10) Pub. No.: US 2021/0130636 A1
(43) Pub. Date: May 6, 2021

(54) FLUID SETS

(71) Applicant: Hewlett-Packard Development Company, L.P., Spring, TX (US)

(72) Inventors: Ronald Albert ASKELAND, San Diego, CA (US); Jie ZHENG, San Diego, CA (US); Dennis Z. GUO, San Diego, CA (US)

(73) Assignee: Hewlett-Packard Development Company, L.P., Spring, TX (US)

(21) Appl. No.: 17/051,229

(22) PCT Filed: Jun. 12, 2019
(86) PCT No.: PCT/US2019/036729

§ 371 Date: Oct. 28, 2020

(30) Foreign Application Priority Data
Aug. 17, 2018 (US) PCTUS2018/046888
Dec. 14, 2018 (US) PCTUS2018/065688
Jan. 9, 2019 (US) PCTUS2019/012862

(51) Int. Cl. C09D 11/54; C09D 11/101; C09D 11/322; C09D 11/38; C09D 11/40; D06P 5/30; D06P 5/22; D06P 1/52; D06P 1/54; B41J 3/407; B41M 5/00; B41M 7/00

(52) U.S. Cl. CPC C09D 11/54; C09D 11/101; C09D 11/322; C09D 11/38; C09D 11/40; B41M 7/0081; D06P 5/22; D06P 1/5278; D06P 1/54; B41J 3/4078; B41M 5/0023; D06P 5/30

(57) ABSTRACT

A fluid set can include a fixer fluid including a fixer vehicle and from 0.5 wt % to 12 wt % of a cationic fixing agent comprising an azetidinium-containing polyamine, a cyan ink composition including a cyan pigment, a magenta ink composition including a magenta pigment, and a yellow ink composition including a yellow pigment. The cyan ink composition, the magenta ink composition, and the yellow ink composition independently include an ink vehicle and from 2 wt % to 15 wt % crosslinkable polymeric binder, and at 10 μm thick, the cyan ink composition, the magenta ink composition, and the yellow ink composition independently exhibit from 40% to 100% energy absorbed when exposed to a common narrow band of UV energy having a peak emission from 310 nm to 440 nm.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions. In one example, textile printing can have various applications including the creation of signs, banners, artwork, apparel, wall coverings, window coverings, upholstery, pillows, blankets, flags, tote bags, clothing, etc.

### BRIEF DESCRIPTION OF THE DRAWINGS

FIG. 1 schematically represents an example fluid set, including an ink composition and a fixer fluid, in accordance with the present disclosure;

FIG. 2 schematically depicts an example textile printing system, including an ink composition, a fixer fluid, and a print media substrate, in accordance with the present disclosure;

FIG. 3A is a graph showing example UV-LED lights by peak wavelength along with their example respective narrow bandwidths and relative irradiance level in accordance with the present disclosure;

FIG. 3B is a graph showing an example ink set with CMYK ink compositions exhibiting a minimum level of UV-energy absorption (%) at 365 nm and at 395 nm to provide for UV-curing across all three colors and black without over-curing any single color in accordance with the present disclosure; and

FIG. 4 depicts an example method of printing in accordance with the present disclosure.

### DETAILED DESCRIPTION

Textile printing has various applications and can provide the print media with various natural fabric textures. In accordance with the present disclosure, one example fluid set includes a fixer fluid of a fixer vehicle and from 0.5 wt % to 12 wt % of a cationic fixing agent comprising an azetidinium-containing polyamine. The fluid set also includes a cyan ink composition including a cyan pigment, a magenta ink composition including a magenta pigment, and a yellow ink composition including a yellow pigment. The cyan ink composition, the magenta ink composition, and the yellow ink composition independently include an ink vehicle and from 2 wt % to 15 wt % crosslinkable polymeric binder (which can be the same or different in the various colored inks). The cyan ink composition, the magenta ink composition, and the yellow ink composition at 10 μm thick independently exhibit from 40% to 100% energy absorbed when exposed to a common narrow band of UV energy having a peak emission from 310 nm to 440 nm. In one example, the fluid set further includes a black ink composition or a gray ink composition including a black pigment. In further detail, the fluid set can further include a secondary ink composition selected from an orange ink composition including an orange pigment, a red ink composition including a red pigment, a green ink composition including a green pigment, a violet ink composition including a violet pigment, or a blue ink composition including a blue pigment, wherein the secondary ink composition at 10 μm thick exhibits from 40% to 100% energy absorbed when exposed to a common narrow band of UV energy having a peak emission from 310 nm to 440 nm. In another example, the crosslinkable polymer can be a polyurethane binder, or the crosslinkable binder can be an acrylic latex binder. The azetidinium-containing polyamine can have a ratio of crosslinked or uncrosslinked azetidinium groups to amine groups of from 0.1:1 to 10:1.

In another example, a printing system includes an ink composition including an ink vehicle, pigment, and from 2 wt % to 15 wt % crosslinkable polymeric binder. The printing system further includes a fixer fluid including a fixer vehicle and from 0.5 wt % to 12 wt % of a cationic fixing agent comprising an azetidinium-containing polyamine. The printing system also includes a UV energy source to emit UV energy having a peak emission from 310 nm to 440 nm. In one example, the system can further include a fabric print media substrate. The azetidinium-containing polyamine can include, for example, from 2 to 12 carbon atoms between individual amine groups.

In another example, a method of printing includes jetting a fixer fluid onto a print media substrate, wherein the fixer fluid includes a fixer vehicle and from 0.5 wt % to 12 wt % of a cationic fixing agent comprising an azetidinium-containing polyamine. The method also includes jetting an ink composition onto the print media substrate in contact with the fixer fluid, wherein the ink composition includes an ink vehicle, pigment, and from 2 wt % to 15 wt % crosslinkable polymeric binder. In further detail, the method includes exposing the print media substrate with the fixer fluid in contact with the ink composition to UV energy having a peak emission from 310 nm to 440 nm. In one example, jetting the fixer fluid, jetting the ink composition, and exposing the print media substrate with the fixer fluid in contact with the ink composition are carried out sequentially. The cationic fixing agent and the crosslinkable polymeric binder can be jetted onto the print media substrate at a weight ratio from 0.01:1 to 1:1. In one example, jetting can be from a thermal inkjet printhead. The fixer fluid can have a surface tension of from 21 dyne/cm to 55 dyne/cm at 25° C. and a viscosity of from 1.5 cP to 15 cP at 25° C. In further detail, jetting the ink composition onto the print media substrate includes jetting multiple ink compositions onto the print media substrate in contact with the fixer fluid. The multiple ink compositions can include a cyan ink composition including a cyan pigment, a magenta ink composition including a magenta pigment, and a yellow ink composition including a yellow pigment, wherein the cyan ink composition, the magenta ink composition, and the yellow ink composition at 10 μm thick independently exhibit from 40% to 100% energy absorbed when exposed to a common narrow band of UV energy having a peak emission from 310 nm to 440 nm.

In addition to that described above, the fluid sets, printing systems, and methods of printing will be described in greater detail hereinafter. It is noted, however, that when discussing the fluid sets, printing systems, and/or methods of printing, these relative discussions can be considered applicable to the other examples, whether or not they are explicitly discussed in the context of that example. Thus, for example, in discussing the fixer fluid related to the fluid sets, such disclosure is also relevant to and directly supported in the context of the printing systems and/or the methods of printing, and vice versa.

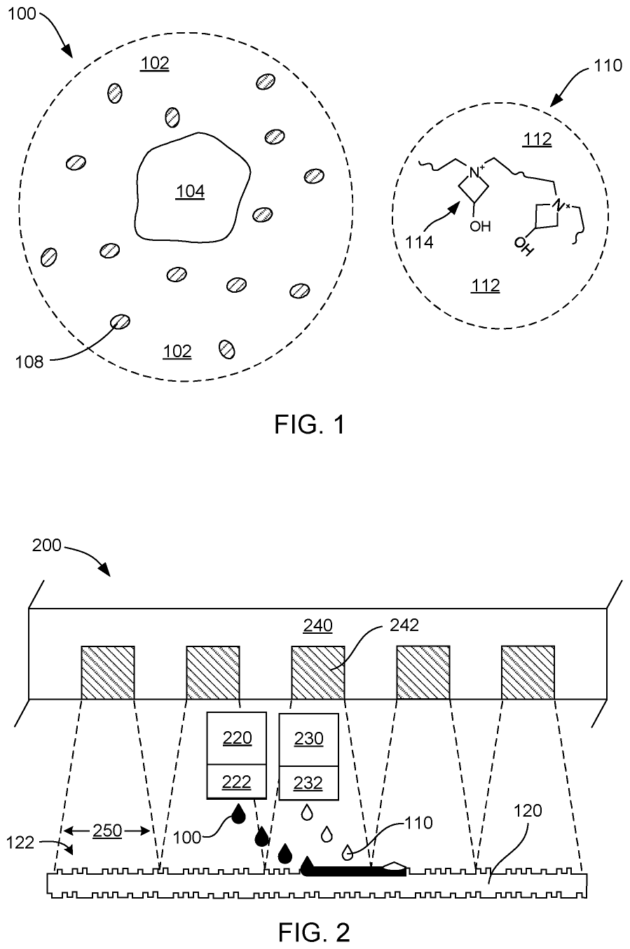

Turning now to FIG. 1, an ink composition 100 can include an ink vehicle 102 (which may include water and organic co-solvent, for example) and pigment 104 (or pigment particles or solids) dispersed therein. Crosslinkable polymeric binder 108 can also be present, such as dispersed polyurethane polymer particles, acrylic latex polymer particles, or the like. As also shown in FIG. 1, a fixer fluid 110 is included and can contain a cationic fixing agent 114 including an azetidinium-containing polyamine in a fixer vehicle 112. In this FIG., the relative sizes of the pigment and the crosslinkable polymeric binder are not drawn to scale. Furthermore, the pigment can further include a dispersing agent or dispersing polymer associated with a surface thereof, e.g., covalently attached as a part of a self-dispersed pigment, or ionically attracted to adsorbed onto the pigment surface, etc., which is not shown. Also, it is notable that the ink vehicle in the ink composition and the fixer vehicle in the fixer fluid may or may not include the same liquid vehicle formulation or component, but in one example they are not the same. Regardless, whether the ink vehicle and the fixer vehicle are the same or different, they can in some examples include common ingredients, such as water, for example or other common organic co-solvents. Whether the same or different, both can also include an organic co-solvent. Thus, any description hereinafter related to any liquid vehicle as it pertains to the ink composition (with ink vehicle) and/or the fixer fluid (with fixer vehicle) is relevant to the other fluid, whether or not explicitly mentioned in that context or not, as both types of fluids can be formulated using the same types of liquid vehicle components.

In further detail regarding the pigment 104, this component can be or include any of a number of pigment colorant of any of a number of primary or secondary colors, or can be black, for example. More specifically, if a color, the color may include cyan, magenta, yellow, orange, red, green, violet, blue, etc. In one example, the ink composition 100 can be a black ink with a carbon black pigment. In another example, the ink composition can be a cyan or green ink with a copper phthalocyanine pigment, e.g., Pigment Blue 15:0, Pigment Blue 15:1; Pigment Blue 15:3, Pigment Blue 15:4, Pigment Green 7, Pigment Green 36, etc. In another example, the ink composition can be a magenta ink with a quinacridone pigment or a co-crystal of quinacridone pigments. Example quinacridone pigments that can be utilized can include PR122, PR192, PR202, PR206, PR207, PR209, P048, P049, PV19, PV42, or the like. These pigments tend to be magenta, red, orange, violet, or other similar colors. In one example, the quinacridone pigment can be PR122, PR202, PV19, or a combination thereof. In another example, the ink composition can be a yellow ink with an azo pigment, e.g., Pigment Yellow 74 and Pigment Yellow 155.

In some examples, the fluid sets, printing systems, and methods of printing can include multiple pigment-based ink compositions, e.g., cyan (C), magenta (M) and yellow (Y); cyan, magenta, yellow, and black (K); cyan, magenta, yellow, and a secondary color ink composition (or multiple secondary color ink compositions) such as orange, red, green, violet, blue, etc.; or cyan, magenta, yellow, black, and a secondary color ink composition (or multiple secondary color ink compositions). Multiple ink compositions can be selected or formulated so that they absorb UV energy emissions from 310 nm to 440 nm, from 330 nm to 430 nm, from 350 nm to 410 nm, from 310 nm to 370 nm, from 350 nm to 370 nm, from 340 nm to 405 nm, or from 365 nm to 405 nm at percent (%) absorptions within the range of from 40% to 100%, from 50% to 100%, from 60% to 100%, from 70% to 100%, or from 80% to 100. Any combination of wavelength ranges and percent absorptions described above can be combined to reach a unique combination of wavelength matched with the percent of absorption for an ink composition or multiple ink compositions within an ink set. With absorption percentages below about 30% (for the multiple ink compositions of the ink compositions of the fluid set, e.g., CMY, washfastness may be imparted to the various colors of the printed color set with adequate application of UV energy, to in many cases, to get to that level of energy application for the various colors present, there may be a risk of damaging the media print media substrate, such as a fabric print media substrate. In other words, there may be a relatively wide range of narrow band UV wavelengths that can be absorbed efficiently by a specific pigments. However, selecting a single narrow band UV wavelength for used across a diverse fluid set, such as a fluid set with cyan, magenta, and yellow, can lead to unbalanced pigment energy absorption, as a wavelength that works well for one color may be inefficient for another color. More specifically, it may be that a single narrow band of UV energy is absorbed very efficiently by yellow or black, but magenta and/or cyan may not efficiently absorb the same narrow band of UV energy. Thus, in order to apply enough to cure the magenta ink, for example, it may be too much energy for the yellow ink, causing burning or over-curing of the yellow portions of the printed image. Thus, in accordance with the present disclosure, by more closely balancing the colored ink absorption properties of the various inks of the fluid set, e.g., CMY or CMYK, the various inks can be sufficiently curable without over-curing any single ink or causing the print media substrate to become burned or adversely impacted by the application of the UV energy.

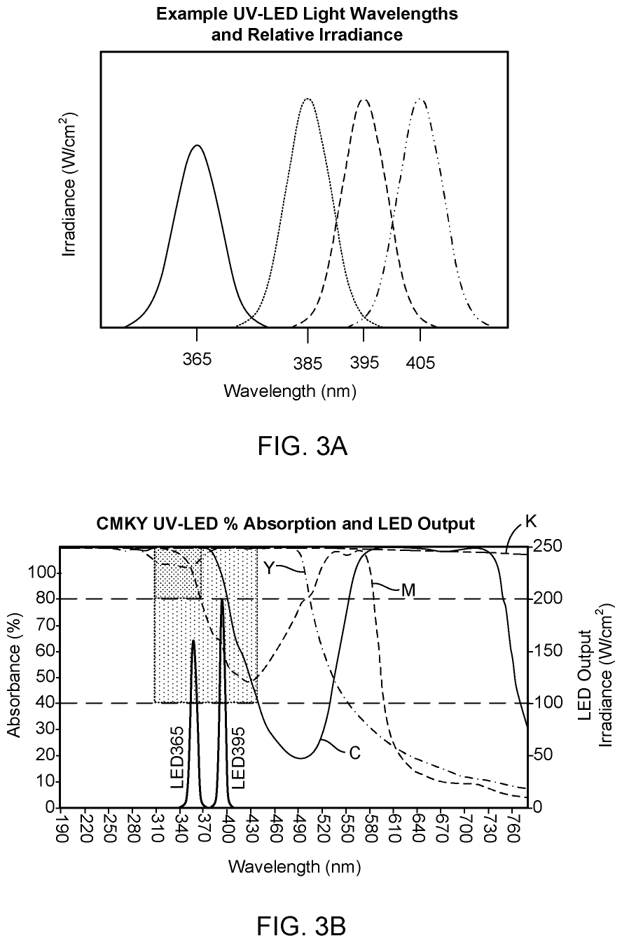

In accordance with this, FIGS. 3A and 3B by way of example, show example UV-LED lights and how pigments can be selected and formulated into ink compositions so that a single narrow band UV-LED wavelength provides an acceptable level of absorbance or percent absorption balance between the various ink compositions of an example ink set, e.g., CMYK, respectively. More specifically, FIG. 3A, is a graph showing four example UV-LED lights that are useable in accordance with the present disclosure. The four UV-LED lights show their peak wavelength, e.g., 365 nm, 385 nm, 395 nm, and 405 nm, along with example respective narrow bandwidths, e.g., less than about 25 nm bandwidth in these examples, as well as their relative irradiance levels, e.g., 365 nm has lower irradiance than 385 nm, 395 nm, and 405 nm in this specific example.

Regarding FIG. 3B more specifically, two of the four narrow band UV-LED light emissions are shown for reference, e.g., 365 nm and 395 nm. In this example, a minimum percent absorption value for the pigments in the colored inks is shown at 40% by dashed line, which can provide a good balance between the various colors of the fluid set, which in this example includes cyan (C), magenta (M), yellow (Y), and black (K). The absorption percentage is based on the percentage (%) of energy absorbed by a 10 μm thick film of ink (loaded with the pigment). In this example, the pigment loading for the various ink compositions for this data was black (K) at 2.75 wt %, cyan (C) at 2.5 wt %, magenta (M) at 3.5 wt %, and yellow (Y) at 4 wt %. Pigments were selected to achieve absorbances (or percent of absorption) above a certain threshold within the UV range. However, notably, if using the narrow band wavelength below about 370 nm, e.g., a UV-LED emitter available that emits 365 nm of UV energy, the percent of energy absorbed of all four colors (CMYK) is above 80%, which allows for even more balance with respect to energy input for curing of the ink compositions than is found at the 395 nm emission also shown in FIG. 3B. In other words, an acceptable threshold for ink composition UV energy absorbed is exemplified in FIG. 3B where the various inks of the fluid set can become sufficiently cured without over-curing the other ink compositions in the fluid set and/or damage the print media substrate, e.g., fabric substrate.

“Absorbance” or “percent (%) energy absorbed” or “percent (%) absorption” can be determined or measured using a UV/Vis spectrophotometer, for example. In one example, the intensity of light passing through a sample compared to the intensity of light before it passes through the sample can be compared to determine the transmittance, which can be expressed as a percentage (% T), and “absorbance” can be determined based on the measured transmittance, e.g., A=−log(% T/100%). 100% transmission indicates 0% absorbance, for example. Alternatively, absorbance can be determined using the Beer-Lambert law based on a known concentration of a species in solution, or using reference tables with molar extinction coefficients, calibration curves, or the like.

To simplify, however, the examples herein were determined based on the “percentage (%) of energy absorbed,” also referred to herein as the “percent or absorption” using a 10 μm thick film of ink (loaded with the pigment). In further detail, the percent (%) energy absorbed can thus equal: (1-10^{-A})×100. By way of example, if the transmittance is 100%, the absorbance is 0 and the % energy absorbed is 0%. If the transmittance is 50%, then the absorbance is 0.3 and the % energy absorbed is 50%. If the transmittance is 10%, the absorbance is 1 and the % energy absorbed is 90%. If the transmittance is 5%, the absorbance is 1.3 and the % energy absorbed is 95. If the transmittance is 1%, then the absorbance is 2.0 and the % energy absorbed is 99%.

With respect to the dispersing agent or dispersing polymer that may be included to disperse the pigment (not shown), in some examples, the pigment 104 can be dispersed by a polymeric or oligomeric dispersant, such as a styrene (meth)acrylate dispersant, or another dispersant suitable for keeping the pigment suspended in the liquid vehicle 102, including dispersants that are covalently attached to, electrostatically attracted to, adsorbed on, etc., a surface of the pigment. Thus, the dispersant can be a separate compound, e.g., polymer and/or oligomer, or can be attached to the surface forming a self-dispersed pigment, e.g., small molecules or oligomers attached to the surface. With respect to polymeric and/or oligomeric dispersant, for example, the dispersant can be any dispersing (meth)acrylate polymer, or other type of polymer, such as a styrene maleic acid copolymer. In one specific example, the (meth)acrylate polymer can be a styrene-acrylic type dispersant polymer, as it can promote Tr-stacking between the aromatic ring of the dispersant and various types of pigments, such as copper phthalocyanine pigments, for example. Examples of commercially available styrene-acrylic dispersants can include Joncryl® 671, Joncryl® 71, Joncryl® 96, Joncryl® 680, Joncryl® 683, Joncryl® 678, Joncryl® 690, Joncryl® 296, Joncryl® 671, Joncryl® 696 or Joncryl® ECO 675 (all available from BASF Corp., Germany).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). This can be the case for either dispersant polymer for pigment dispersion or for crosslinkable polymer binder described hereinafter that may include co-polymerized acrylate and/or methacrylate monomers, e.g., acrylic latex binder. Also, in some examples, the terms “(meth)acrylate” and “(meth)acrylic acid” can be used interchangeably, as acrylates and methacrylates described herein include salts of acrylic acid and methacrylic acid, respectively. Thus, mention of one compound over another can be a function of pH. Furthermore, even if the monomer used to form the polymer was in the form of a (meth)acrylic acid during preparation, pH modifications during preparation or subsequently when added to an ink composition can impact the nature of the moiety as well (acid form vs. salt form). Thus, a monomer or a moiety of a polymer described as (meth)acrylic acid or as (meth)acrylate should not be read so rigidly as to not consider relative pH levels, and other general organic chemistry concepts.

In further detail, the ink composition 100 can also include a crosslinkable polymeric binder 108, such as a polyurethane binder and/or an acrylic latex binder. The crosslinkable polymeric binder can be present in the ink composition(s) in an amount from 2 wt % to 15 wt %. In other examples, the crosslinkable polymeric binder can be present in the ink compositions(s) in an amount from 3 wt % to 11 wt %. In yet other examples, the crosslinkable polymeric binder can be present in the ink composition(s) in an amount from 4 wt % to 10 wt %. In still other examples, the crosslinkable polymeric binder can be present in the ink composition(s) in an amount from 5 wt % to 9 wt %.

Regarding the polyurethane binders in particular, there are a variety of these types of polymers that can be used. In one example, the polyurethane binder can be a polyester-polyurethane binder. In other examples, the polyurethane binder can be a sulfonated polyester-polyurethane. In another example, the sulfonated polyester-polyurethane binder can be anionic. In further detail, the sulfonated polyester-polyurethane binder can also be aliphatic including saturated carbon chains therein as part of the polymer backbone or side-chain thereof, e.g., C2 to C10, C3 to C8, or C3 to C6 alkyl. These polyester-polyurethane binders can be described as “alkyl” or “aliphatic” because these carbon chains are saturated and because they are devoid of aromatic moieties. An example anionic aliphatic polyester-polyurethane binder that can be used is Impranil® DLN-SD (Mw 133,000 Mw; Acid Number 5.2; Tg −47° C.; Melting Point 175-200° C.) from Covestro (Germany). Example components used to prepare the Impranil® DLN-SD or other similar anionic aliphatic polyester-polyurethane binders can include pentyl glycols, e.g., neopentyl glycol; C4-C10 alkyldiol, e.g., hexane-1,6-diol; C4 to C10 alkyl dicarboxylic acids, e.g., adipic acid; C4 to C10 alkyl diisocyanates, e.g., hexamethylene diisocyanate (HDI); diamine sulfonic acids, e.g., 2-[(2-aminoethyl)amino]-ethanesulfonic acid; etc. Alternatively, the polyester-polyurethane binder can be aromatic (or include an aromatic moiety) along with aliphatic chains. An example of an aromatic polyester-polyurethane binder that can be used is Dispercoll® U42. Example components used to prepare the Dispercoll® U42 or other similar aromatic polyester-polyurethane binders can include aromatic dicarboxylic acids, e.g., phthalic acid; C4 to C10 alkyl dialcohols, e.g., hexane-1,6-diol; C4 to C10 alkyl diisocyanates, e.g., hexamethylene diisocyanate (HDI); diamine sulfonic acids, e.g., 2-[(2-aminoethyl)amino]-ethanesulfonic acid; etc. Other types of polyester-polyurethanes can also be used, including Impranil® DL 1380, which can be somewhat more difficult to jet from thermal inkjet printheads compared to Impranil® DLN-SD and Dispercoll® U42, but still can be acceptably jetted in some examples, and can also provide acceptable washfastness results on a variety of fabric types, e.g., cotton, polyester, cotton/polyester blends, nylon, etc.

Regarding acrylic latex binder particles, a variety of acrylic latexes can be used, including dispersed polymer prepared from acrylate and/or methacrylate monomers. In one example, the acrylic latex particles can be prepared from an aromatic (meth)acrylate monomer that results in aromatic (meth)acrylate moieties as part of the acrylic latex. In other examples, linear aliphatic (meth)acrylate moieties can be used to form acrylic latexes linear aliphatic groups. In other examples, cycloaliphatic (meth)acrylate moieties can be used to form acrylic latexes with cycloaliphatic groups. In still other examples, combinations aromatic, linear aliphatic, and/or cycloaliphatic (meth)acrylates can be used to form acrylic latex particles with various types chains and/or side groups, for example. In other examples, the acrylic latex particles can include a single heteropolymer that is homogenously copolymerized. In still other examples, a multi-phase acrylic latex polymer can be prepared that includes a first heteropolymer and a second heteropolymer (or a third heteropolymer, fourth, etc.). Multiple heteropolymers can be physically separated in the acrylic latex particles, such as in a core-shell configuration, a two-hemisphere configuration, smaller spheres of one phase distributed in a larger sphere of the other phase, interlocking strands of the two phases, and so on. If a two-phase polymer, the first heteropolymer phase can be polymerized from two or more aliphatic (meth)acrylate ester monomers or two or more aliphatic (meth)acrylamide monomers. The second heteropolymer phase can be polymerized from a cycloaliphatic monomer, such as a cycloaliphatic (meth)acrylate monomer or a cycloaliphatic (meth)acrylamide monomer. The first or second heteropolymer phase can include the aromatic (meth)acrylate monomer, e.g., phenyl, benzyl, naphthyl, etc. In one example, the aromatic (meth)acrylate monomer can be a phenoxylalkyl (meth)acrylate that forms a phenoxylalkyl (meth)acrylate moiety within the acrylic latex polymer, e.g. phenoxylether, phenoxylpropyl, etc. The second heteropolymer phase can have a higher T_{g} than the first heteropolymer phase in one example. The first heteropolymer composition may be considered a soft polymer composition and the second heteropolymers composition may be considered a hard polymer composition. If a two-phase heteropolymer, the first heteropolymer composition can be present in the acrylic latex polymer in an amount ranging from 15 wt % to 70 wt % of a total weight of the polymer particle, and the second heteropolymer composition can be present in an amount ranging from 30 wt % to 85 wt % of the total weight of the polymer particle.

In more general terms, whether there is a single heteropolymer phase, or there are multiple heteropolymer phases, heteropolymer(s) or copolymer(s) can include a number of various types of copolymerized monomers, including aliphatic(meth)acrylate ester monomers, such as linear or branched aliphatic (meth)acrylate monomers, cycloaliphatic (meth)acrylate ester monomers, or aromatic monomers. However, in accordance with the present disclosure, the aromatic monomer(s) selected for use can include an aromatic (meth)acrylate monomer.

Examples of aromatic (meth)acrylate monomers that can be used in a heteropolymer or copolymer of the acrylic latex (single-phase, dual-phase in one or both phases, etc.) include 2-phenoxylethyl methacrylate, 2-phenoxylethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, naphthyl methacrylate, naphthyl acrylate, phenyl methacrylate, phenyl acrylate, or a combination thereof. In one example, the acrylic latex polymer can include a phenoxylethyl acrylate and a phenoxylethyl methacrylate, or a combination of a phenoxylethyl acrylate and phenoxylethyl methacrylate.

Examples of the linear aliphatic (meth)acrylate monomers that can be used include ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof.

Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

In other examples, the acrylic latex binder can include polymerized copolymers, such as emulsion polymers, of one or more monomer, and can also be prepared using a reactive surfactant in some examples. Exemplary reactive surfactants can include polyoxyethylene alkylphenyl ether ammonium sulfate surfactant, alkylphenol ethoxylate free polymerizable anonioc surfactant, sodium polyoxyethylene alkylether sulfuric ester based polymerizable surfactant, or a combination thereof. Commercially available examples include Hitenol® AR series, Hitenol® KH series (e.g. KH-05 or KH-10), or Hitenol® BC series, e.g., Hitenol® BC-10, BC-30, (all available from Montello, Inc., Oklahoma), or combinations thereof. Exemplary monomers that can be used include styrene, alkyl methacrylate (for example C1 to C8 alkyl methacrylate), alkyl methacrylamide (for example C1 to C8 alkyl methacrylamide), butyl acrylate, methacrylic acid, or combinations thereof. In some examples, the acrylic latex particles can be prepared by combining the monomers as an aqueous emulsion with an initiator. The initiator may be selected from a persulfate, such as a metal persulfate or an ammonium persulfate. In some examples, the initiator may be selected from a sodium persulfate, ammonium persulfate or potassium persulfate.

Returning now to FIG. 1, the ink composition 100 of the present disclosure can be formulated to include an ink vehicle 102, which can include the water content, e.g., 60 wt % to 90 wt % or from 75 wt % to 85 wt %, as well as organic co-solvent, e.g., from 4 wt % to 30 wt %, from 6 wt % to 20 wt %, or from 8 wt % to 15 wt %. Other liquid vehicle components can also be included, such as surfactant, antibacterial agent, other colorant, etc. However, as part of the ink composition, pigment (and dispersant) and the crosslinkable polymeric binder can be included or carried by the ink vehicle components.

In further detail, co-solvent(s) can be present and can include any co-solvent or combination of co-solvents that is compatible with the pigment, dispersant, crosslinkable polymeric binder, etc. Examples of suitable classes of co-solvents include polar solvents, such as alcohols, amides, esters, ketones, lactones, and ethers. In additional detail, solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, e.g., Dowanol™ TPM (from Dow Chemical, USA), higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. More specific examples of organic solvents can include 2-pyrrolidone, 2-ethyl-2-(hydroxymethyl)-1, 3-propane diol (EPHD), glycerol, dimethyl sulfoxide, sulfolane, glycol ethers, alkyldiols such as 1,2-hexanediol, and/or ethoxylated glycerols such as LEG-1, etc.

The ink vehicle can also include surfactant. In general, the surfactant can be water soluble and may include alkyl polyethylene oxides, alkyl phenyl polyethylene oxides, polyethylene oxide (PEO) block copolymers, acetylenic PEO, PEO esters, PEO amines, PEO amides, dimethicone copolyols, ethoxylated surfactants, alcohol ethoxylated surfactants, fluorosurfactants, and mixtures thereof. In some examples, the surfactant can include a nonionic surfactant, such as a Surfynol® surfactant, e.g., Surfynol® 440 (from Evonik, Germany), or a Tergitol™ surfactant, e.g., Tergitol™ TMN-6 (from Dow Chemical, USA). In another example, the surfactant can include an anionic surfactant, such as a phosphate ester of a C10 to C20 alcohol or a polyethylene glycol (3) oleyl mono/di phosphate, e.g., Crodafos® N3A (from Croda International PLC, United Kingdom). The surfactant or combinations of surfactants, if present, can be included in the ink composition at from 0.01 wt % to 5 wt % and, in some examples, can be present at from 0.05 wt % to 3 wt % of the ink compositions.

Consistent with the formulations of the present disclosure, various other additives may be included to provide desired properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Acticide®, e.g., Acticide® B20 (Thor Specialties Inc.), Nuosept™ (Nudex, Inc.), Ucarcide™ (Union carbide Corp.), Vancide® (R.T. Vanderbilt Co.), Proxel™ (ICI America), and combinations thereof. Sequestering agents such as EDTA (ethylene diamine tetra acetic acid) may be included to eliminate the deleterious effects of heavy metal impurities, and buffer solutions may be used to control the pH of the ink. Viscosity modifiers and buffers may also be present, as well as other additives to modify properties of the ink as desired.

Turning now to further description regarding the fixer fluid 100 in FIG. 1, as shown, the fixer fluid includes a fixer vehicle 112, which can include water and an organic co-solvent. As mentioned, the description related to the ink vehicle 102 of the ink composition(s) 100 are relevant to the fixer vehicle formulations. In further detail, however, the fixer fluid can include water in an amount from 65 wt % to 96 wt %. In other examples, water can be present in the fixer fluid in an amount from 70 wt % to 90 wt %. In still other examples, water can be present in the fixer fluid in an amount from 75 wt % to 85 wt %. Organic co-solvent can typically be present in the fixer fluid in an amount from 1.5 wt % to 34.5 wt %. In some examples, organic co-solvent can be present in the fixer fluid in an amount from 4 wt % to 20 wt %. In another examples, organic co-solvent can be present in the fixer fluid in an amount from 6 wt % to 16 wt %, or from 8 wt % to 14 wt %. Other liquid vehicle components can also be included, such as surfactant, antibacterial agent, colorant, etc.

With specific reference to the cationic fixing agent 114, which includes an azetidinium-containing polyamine, a representative simplified schematic formula is provided as Formula I, which is included for illustrative purposes only. The cationic fixing agent can be selected for use from any of a number of cationic polyamines with a plurality of azetidinium groups. In an uncrosslinked state, as shown in FIG. 1, as well as in Formula I below, an azetidinium group generally has a structure as follows:

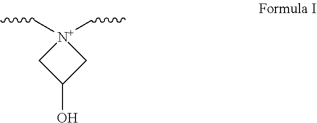

In some examples, the cationic fixing agent including the azetidinium-containing polyamine can be derived from the reaction of a polyalkylene polyamine (e.g. ethylenediamine, bishexamethylenetriamine, and hexamethylenediamine, for example) with an epihalohydrin (e.g. epichlorohydrin, for example) (referred to as PAmE resins). In some specific examples, the cationic fixing agents including an azetidinium-containing polyamine can include the structure:

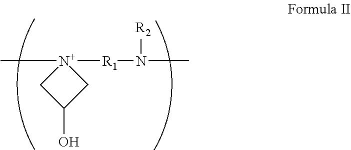

where R₁ can be a substituted or unsubstituted C₂-C₁₂ linear alkyl group and R₂ is H or CH₃. In some additional examples, R₁ can be a C₂-C₁₀, C₂-C₈, or C₂-C₆ linear alkyl group. More generally, there can typically be from 2 to 12 carbon atoms between amine groups (including azetidinium groups) in the azetidinium-containing polyamine. In other examples, there can be from 2 to 10, from 2 to 8, or from 2 to 6 carbon atoms between amine groups in the azetidinium-containing polyamine. In some examples, where R₁ is a C₃-C₁₂ (or C₃-C₁₀, C₃-C₈, C₃-C₆, etc.) linear alkyl group, a carbon atom along the alkyl chain can be a carbonyl carbon, with the proviso that the carbonyl carbon does not form part of an amide group (i.e. R₁ does not include or form part of an amide group). In some additional examples, a carbon atom of R₁ can include a pendent hydroxyl group.

As can be seen in Formula lithe cationic fixing agent can include a quaternary amine (e.g. azetidinium group) and a non-quaternary amine (i.e. a primary amine, a secondary amine, a tertiary amine, or a combination thereof). In some specific examples, the cationic fixing agent can include a quaternary amine and a tertiary amine. In some additional examples, the cationic fixing agent can include a quaternary amine and a secondary amine. In some further examples, the cationic fixing agent can include a quaternary amine and a primary amine. It is noted that, in some examples, some of the azetidinium groups of the cationic fixing agent can be crosslinked to a second functional group along the azetidinium-containing polyamine. Whether or not this is the case, the azetidinium-containing polyamine can have a ratio of crosslinked or uncrosslinked azetidinium groups to other amine groups of from 0.1:1 to 10:1. In other examples, the azetidinium-containing polyamine can have a ratio of crosslinked or uncrosslinked azetidinium groups to other amine groups of from 0.5:1 to 2:1. Non-limiting examples of commercially available azetidinium-containing polyamines that fall within these ranges of azetidinium group to amine groups include Crepetrol™ 73, Kymene™ 736, Polycup™ 1884, Polycup™ 7360, and Polycup™ 7360A each available from Solenis LLC (Delaware, USA).

Thus, when the fixer fluid is printed on the print media substrate (not shown in FIG. 1, but shown in FIG. 2), suitable reactive groups that may be present at a surface of the crosslinkable polymeri binder in the ink composition, and in some instances, hydroxyl groups (e.g. for cotton), amine groups (e.g. for nylon), thiol groups (e.g. for wool), or other suitable reactive groups that may be present at the surface of the print media substrate, can interact with the azetidinium groups in the fixer fluid to generate a high quality image that exhibits durable washfastness as demonstrated in the examples hereinafter. The cationic fixing agent including an azetidinium-containing polyamine can be present in the fixer fluid at from 0.5 wt % to 12 wt %, from 1 wt % to 7 wt %, from 2 wt % to 6 wt %, from 3 wt % to 5 wt %, or from 3 wt % to 6 wt %, for example.

Non-limiting but illustrative example reactions between the azetidinium group and various reactive groups are illustrated below in Formulas as follows:

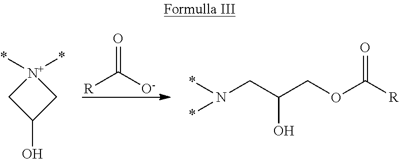

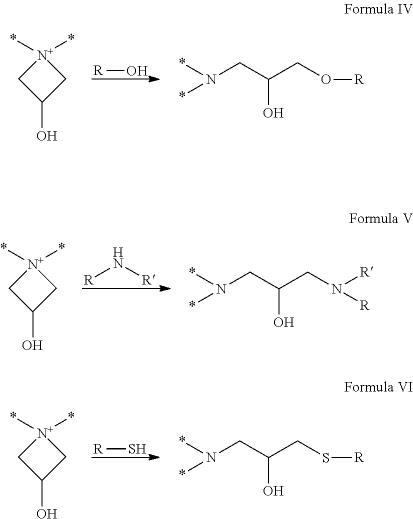

In Formulas the asterisks (*) represent portions of the various organic compounds that may not be directly part of the reaction shown in Formulas and are thus not shown, but could be any of a number of organic groups or functional moieties, for example. Likewise, R and R′ can be H or any of a number of organic groups, such as those described previously in connection with R₁ or R₂ in Formula II, without limitation.

In further detail, in accordance with examples of the present disclosure, the azetidinium groups present in the fixer fluid can interact with the crosslinkable polymeric binder, the print media substrate, or both to form a covalent linkage therewith, as shown in Formulas III-VI above. Other types of reactions can also occur, but Formulas III-VI are provided by way of example to illustrate examples of reactions that can occur when the ink composition, the print media substrate, or both come into contact with the fixer fluid, e.g., interaction or reaction with the substrate, interaction or reaction between different types of crosslinkable polymeric binder, interaction or reaction between different types of azetidinium-containing polyamines, interactions or reactions with different molar ratios (other than 1:1, for example) than that shown in Formulas etc.

As shown in FIG. 2, a printing system 200 schematically depicts an ink composition 100 and a fixer fluid 110 for printing on a print media substrate 120. In one example, the printing system can be a textile printing system, where the print media substrate is a textile or fabric substrate. In some examples, the printing system can further include various architectures related to ejecting fluids and treating fluids after ejecting onto the print media substrate. For example, the ink composition can be printed from an inkjet pen 220 which includes an ejector 222, such as a thermal inkjet ejector or some other digital ejector technology. Likewise, the fixer fluid can be printed from a fluidjet pen 230 which includes an ejector 232, such as a thermal ejector or some other digital ejector technology. The inkjet pen and the fluidjet pen can be the same type of ejector or can be two different types of ejectors. Both may be thermal inkjet ejectors, for example.

Also shown in FIG. 2 is a UV energy source 240, which in this example may be an array of UV LED light 242, for example, which collective can emit UV energy 250 to an exposure area 122 at a surface of the print media substrate 120, e.g., fabric substrate. In some examples, areas of the print media substrate that does not have the printing fluids 100, 110 applied thereto may not absorb as much of the UV energy as areas with printed fluids thereon. The use of a UV energy source, such as a high intensity, narrow bandwidth, UV energy source that can be provided by UV LED lights, can provide enough energy to cause crosslinking of the crosslinkable polymer to occur in a relatively short period of time. In one example, the azetidinium groups of the fixer fluid can interact with the crosslinkable polymeric binder (of the ink composition 100), the print media substrate 120, or both to form a covalent linkage therewith, e.g., causing the crosslinking reaction to occur or accelerate or both.

As used in this specification and the associated claims, “high intensity” indicates a system capable of applying a narrow band of UV energy with an energy application of 3 J/(cm²·sec) or greater, 5 J/(cm²·sec) or greater, or 8 J/(cm²·sec) or greater. The system may apply J/(cm²·sec). The system may apply 8 J/(cm²·sec). Higher energy intensities may allow for shorter ON periods (when pulsing or when cycling on and off, such as for temperature control), and in some instances, may allow faster throughput. Higher energy intensities in some instances may also induce melting, browning, and/or damage to a print medium. In some examples, a pulsed application of high intensity UV emissions produces crosslinking while avoiding damage.

As used in this specification the term “narrow band” refers to the emission of energy, e.g., UV energy, where about 90% to 100% of the energy output of a light energy source falls within about a 50 nm bandwidth range, or in one example, within a 30 nm bandwidth range. The bandwidths shown in FIG. 3A, for example, have a narrow bandwidth where about 90% to 100% of the energy output is within about a 20 nm bandwidth range.

The “peak emission” of a light energy source refers to the wavelength of light where the highest level of energy output is found, and may be found at about the center of the bandwidth. Peak emissions can be within the 310 nm to 440 nm range. In a few specific examples, a peak emission of 365 nm, 385 nm, 395 nm, or 405 nm are shown in FIG. 3A by example, with the bandwidth range represented essentially equally on both sides of the peak. In some instances, the peak emission may be offset from the center position within the narrow bandwidth range (not shown), but is found somewhere within the narrow bandwidth range of energy emitted or emitable from the light energy source.

UV energy emissions, such as from narrow band LED light sources, for example, can be directed toward the print media substrate as high intensity pulsed energy, or as continuous energy for relatively short periods of time, e.g., less than about 5 seconds. For example, the UV energy source may be applied for a period of less than about 5 seconds, less than about 3 seconds, less than about 1 second, or for even short periods of time. Other ranges of UV exposure can be less than about 500 millisecond, less than about 250 millisecond, less than about 100 millisecond, less than about 50 millisecond, less than about 10 millisecond, from about 10 millisecond to about 1 second, from about 50 millisecond to about 1 second, from about 250 millisecond to about 2 seconds, from about 10 millisecond to about 500 millisecond, from about 50 millisecond to about 500 millisecond, from about 250 millisecond to about 5 seconds, etc.

The ink compositions 100 and fixer fluids 110 may be suitable for printing on many types of print media substrates 120, such as paper, textiles, etc. Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the fabric substrates can include polymeric fibers such as, nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E. I. du Pont de Nemours Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, a copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

The fabric substrate can be in one of many different forms, including, for example, a textile, a cloth, a fabric material, fabric clothing, or other fabric product suitable for applying ink, and the fabric substrate can have any of a number of fabric structures. The term “fabric structure” is intended to include structures that can have warp and weft, and/or can be woven, non-woven, knitted, tufted, crocheted, knotted, and pressured, for example. The terms “warp” and “weft” have their ordinary meaning in the textile arts, as used herein, e.g., warp refers to lengthwise or longitudinal yarns on a loom, while weft refers to crosswise or transverse yarns on a loom.

It is notable that the term “fabric substrate” or “fabric media substrate” does not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into a finished article (e.g. clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of 90°. This woven fabric can include but is not limited to, fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of two or more of these processes.

As previously mentioned, the fabric substrate can be a combination of fiber types, e.g. a combination of any natural fiber with another natural fiber, any natural fiber with a synthetic fiber, a synthetic fiber with another synthetic fiber, or mixtures of multiple types of natural fibers and/or synthetic fibers in any of the above combinations. In some examples, the fabric substrate can include natural fiber and synthetic fiber. The amount of various fiber types can vary. For example, the amount of the natural fiber can vary from 5 wt % to 95 wt % and the amount of synthetic fiber can range from 5 wt % to 95 wt %. In yet another example, the amount of the natural fiber can vary from 10 wt % to 80 wt % and the synthetic fiber can be present from 20 wt % to 90 wt %. In other examples, the amount of the natural fiber can be 10 wt % to 90 wt % and the amount of synthetic fiber can also be 10 wt % to 90 wt %. Likewise, the ratio of natural fiber to synthetic fiber in the fabric substrate can vary. For example, the ratio of natural fiber to synthetic fiber can be 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa.

In one example, the fabric substrate can have a basis weight ranging from 10 gsm to 500 gsm. In another example, the fabric substrate can have a basis weight ranging from 50 gsm to 400 gsm. In other examples, the fabric substrate can have a basis weight ranging from 100 gsm to 300 gsm, from 75 gsm to 250 gsm, from 125 gsm to 300 gsm, or from 150 gsm to 350 gsm.

In addition, the fabric substrate can contain additives including, but not limited to, colorant (e.g., pigments, dyes, and tints), antistatic agents, brightening agents, nucleating agents, antioxidants, UV stabilizers, fillers and lubricants, for example. Alternatively, the fabric substrate may be pre-treated in a solution containing the substances listed above before applying other treatments or coating layers.

Regardless of the substrate, whether paper, natural fabric, synthetic fabric, fabric blend, treated, untreated, etc., the print media substrates printed with the fluid sets of the present disclosure can provide acceptable optical density (OD) and/or washfastness properties. The term “washfastness” can be defined as the OD that is retained or delta E (ΔE) after five (5) standard washing machine cycles using warm water and a standard clothing detergent (e.g., Tide® available from Proctor and Gamble, Cincinnati, Ohio, USA). Essentially, by measuring OD and/or L*a*b* both before and after washing, ΔOD and ΔE value can be determined, which is essentially a quantitative way of expressing the difference between the OD and/or L*a*b* prior to and after undergoing the washing cycles. Thus, the lower the ΔOD and ΔE values, the better. In further detail, ΔE is a single number that represents the “distance” between two colors, which in accordance with the present disclosure, is the color (or black) prior to washing and the modified color (or modified black) after washing.

Colors, for example, can be expressed as CIELAB values. It is noted that color differences may not be symmetrical going in both directions (pre-washing to post washing vs. post-washing to pre-washing). Using the CIE 1976 definition, the color difference can be measured and the ΔE value calculated based on subtracting the pre-washing color values of L*, a*, and b* from the post-washing color values of L*, a*, and b*. Those values can then be squared, and then a square root of the sum can be determined to arrive at the ΔE value. The 1976 standard can be referred to herein as “ΔE_{CIE}.” The CIE definition was modified in 1994 to address some perceptual non-uniformities, retaining the L*a*b* color space, but modifying to define the L*a*b* color space with differences in lightness (L*), chroma (C*), and hue (h*) calculated from L*a*b* coordinates. Then in 2000, the CIEDE standard was established to further resolve the perceptual non-uniformities by adding five corrections, namely i) hue rotation (RT) to deal with the problematic blue region at hue angles of 275°), ii) compensation for neutral colors or the primed values in the L*C*h differences, iii) compensation for lightness (S_{L}), iv) compensation for chroma (S_{C}), and v) compensation for hue (S_{H}). The 2000 modification can be referred to herein as “ΔE₂₀₀₀.” In accordance with examples of the present disclosure, ΔE value can be determined using the CIE definition established in 1976, 1994, and 2000 to demonstrate washfastness. However, in the examples of the present disclosure, ΔE_{CIE} and ΔE₂₀₀₀ are used. Further, in 1984, a difference measurement, based on a L*C*h model was defined and called CMC I:c. This metric has two parameters: lightness (I) and chroma (c), allowing users to weight the difference based on the ratio of I:c that is deemed appropriate for the application. Commonly used values include 2:1 for acceptability and 1:1 for threshold of imperceptibility. This difference metric is also reported in various examples of the present disclosure.

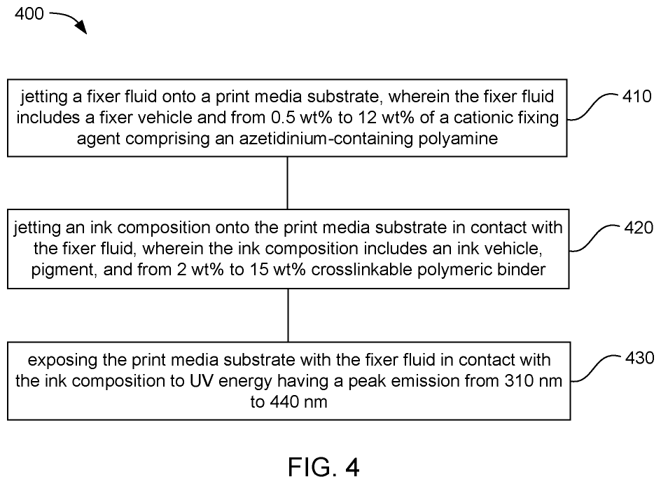

In another example, and as set forth in FIG. 4, a method 400 of printing can include jetting 410 a fixer fluid onto a print media substrate, wherein the fixer fluid includes a fixer vehicle and from 0.5 wt % to 12 wt % of a cationic fixing agent comprising an azetidinium-containing polyamine. The method can also include jetting 420 an ink composition onto the print media substrate in contact with the fixer fluid, wherein the ink composition includes an ink vehicle, pigment, and from 2 wt % to 15 wt % crosslinkable polymeric binder. In further detail, the method can include exposing 430 the print media substrate with the fixer fluid in contact with the ink composition to UV energy having a peak emission from 310 nm to 440 nm. In one example, jetting the fixer fluid, jetting the ink composition, and exposing the print media substrate with the fixer fluid in contact with the ink composition are carried out sequentially. The cationic fixing agent and the crosslinkable polymeric binder can be jetted onto the print media substrate at a weight ratio from 0.01:1 to 1:1. In one example, jetting can be from a thermal inkjet printhead. In further detail, jetting the ink composition onto the print media substrate includes jetting multiple ink compositions onto the print media substrate in contact with the fixer fluid. The multiple ink compositions can include a cyan ink composition including a cyan pigment, a magenta ink composition including a magenta pigment, and a yellow ink composition including a yellow pigment, wherein the cyan ink composition, the magenta ink composition, and the yellow ink composition exhibit an absorbance equivalent to 40% to 100% energy absorbed when exposed to a common narrow band of the UV energy.

For purposes of good jettability, the fixer fluid can typically have a surface tension of from 21 dyne/cm to 55 dyne/cm at 25° C. and a viscosity of from 1.5 cP to 15 cP at 25° C., which is particularly useful for thermal ejector technology, though surface tensions outside of this range can be used for some types of ejector technology, e.g., piezoelectric ejector technology. Surface tension can be measured by the Wilhelmy plate method with a Kruss tensiometer.

It is also noted that the method of printing includes UV curing the fixer fluid and the ink composition using UV energy having a peak wavelength from about 310 nm to about 440 nm, for example, for a time-frame as disclosed herein.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those in the field technology determine based on experience and the associated description herein.

As used herein, a plurality of items, structural elements, compositional elements, and/or materials may be presented in a common list for convenience. However, these lists should be construed as though individual member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also all the individual numerical values or sub-ranges encompassed within that range as if individual numerical values and sub-ranges are explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following are only exemplary or illustrative of the application of the principles of the presented fabric print media and associated methods. Numerous modifications and alternatives may be devised without departing from the present disclosure. The appended claims are intended to cover such modifications and arrangements. Thus, while the disclosure has been provided with particularity, the following describes further detail in connection with what are presently deemed to be the acceptable examples.

### Example 1—Preparation of Ink Compositions and Ink Sets

Four ink sets including four individual aqueous ink compositions were prepared. Individual ink compositions included from 1.5 wt % to 4 wt % pigment content and 5 wt % to 8 wt % crosslinkable polymeric binder content, and furthermore were formulated with appropriate water content and organic solvent suitable for thermal ejection from a thermal inkjet printer. The pigment and crosslinkable polymeric binder loading varied to some degree based on considerations such as thermal ejectability and nozzle health, color strength and balance, and/or other considerations. The various ink sets included cyan (C) ink composition, magenta (M) ink composition, a yellow (Y) ink composition, and black (K) ink composition. Ink Sets 1 and 2 included polyurethane particles as the crosslinkable polymeric binder. As a note, the magenta ink composition and the yellow ink compositions were the same in Ink Set 1 and Ink Set 2 (cyan and black were different). Ink Sets 3 and 4 included acrylic latex particles as the crosslinkable polymeric binder. Both Ink Sets 3 and 4 were different across all four ink compositions. For purposes of identification:
Ink Set 1 included ink compositions identified herein as C1, M1, Y1, and K1 with pigment loading concentrations from about 2.5 wt % to about 3 wt % and polyurethane loading concentrations of about 6 wt %. The polyurethane binder was an anionic aliphatic polyester-polyurethane binder.
Ink Set 2 included ink compositions identified herein as C2, M2, Y2, and K2 with pigment loading concentrations from about 1.5 wt % to about 3 wt % and an acrylic latex particle loading concentrations of about 7 wt %. The acrylic latex particle included a copolymer of styrene, methyl methacrylate, butyl acrylate and methacrylic acid.
Ink Set 3 included ink compositions identified herein as C3, M3, Y3, and K3 with pigment loading concentrations from about 1.7 wt % to about 3.9 wt % and an acrylic latex particle loading concentrations of about 10 wt %. The acrylic latex particles included a heteropolymer: Phase-one included methyl methacrylate, butyl acrylate, and methacrylic acid; Phase-two included cyclohexyl methacrylate, cyclohexyl acrylate, phenoxylethyl methacrylate, and methacrylic acid.

### Example 2—Preparation of Fixer Fluid

A fixer fluid including an azetidinium-containing polyamine was prepared that included 12 wt % 2-pyrrolidone (organic cosolvent), 0.3 wt % Surfynol® 440 (surfactant from Evonik, Germany), and 4 wt % Polycup™ 7360A (azetidinium-containing polyamine from Solenis LLC, USA). The fixer fluid had a surface tension of about 30-33 cP and a pH of about 4.

### Example 3—Optical Density and L*a*b* Color Properties Before and after Wash Durability Challenge

Fourteen (12) ink compositions from Ink Sets 1-3 of Example 1 were printed on fabric substrates in multiple layers relative to the fixer fluid prepared in accordance with Example 2. The 12 inks were also printed without fixer fluid for comparison purposes. The fabric substrates selected for testing were gray cotton fabric and Gildan white 780 100 wt % cotton fabric

Where fixer fluid was used, the fixer fluids and the ink compositions were applied wet-on-wet in two passes as follows:
Pass 1-5 grams per square meter (gsm) fixer fluid and 10 gsm ink composition; and
Pass 2-5 gsm fixer fluid and 10 gsm ink composition.
   In instances where ink composition was applied without fixer fluid (for comparison purposes), the ink was applied in two passes, as follows:
Pass 1-10 gsm ink composition; and
Pass 2-10 gsm ink composition.

The various printed samples were then either cured or left uncured to compare cured printed fabric samples to uncured printed fabric samples (both with and without fixer fluid). For a curing comparison, some of printed fabric samples were subjected to 150° C. of heat in a Clam Shell Press for 3 minutes. In accordance with examples of the present disclosure, some of the printed fabric samples were subjected to LED395 UV energy (395 nm UV energy; 1 second exposure; 50% power; 6.62 J/cm²·sec). The LED395 energy was applied after Pass 2 in all instances, but with Ink Set 1, the LED395 energy was also applied after Pass 1 (e.g., twice as much energy was applied compared to the energy applied after Pass 2 only).

The various printed fabric samples were measured for Optical Density (OD) initially after printing (and curing where applicable). Then, the printed fabric samples were washed 5 times with Sears Kenmore 90 Series Washer and warm water (about 40° C.) with detergent and air drying between washes. The samples were measured again for OD (after 5 washes) and L*a*b* before and after the 5 washes. After the five cycles, optical density (OD) and L*a*b* values were measured for comparison, and delta E (ΔE) values were calculated using the 1976 standard denoted as ΔE_{CIE} as well as the 2000 standard denoted as ΔE₂₀₀₀. ΔE_{CMC} (2:1) values are also reported, which refers to yet another alternative standard for color difference. Results are depicted in Tables 1A to 2C, as follows:

TABLE 1A
100% Cotton Woven Fabric; LED395,
50% Energy, 1 Second after Pass 2

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.159 | 1.080 | −6.8 | 3.44 | 2.95 | 3.00 |
| 1/C1 | No | 1.072 | 0.897 | −16.4 | 6.13 | 3.97 | 2.80 |
| 1/M1 | No | 1.044 | 0.874 | −16.3 | 6.97 | 3.29 | 2.84 |
| 1/Y1 | No | 1.001 | 0.834 | −16.6 | 4.96 | 1.18 | 1.62 |
| 1/K1 | Yes | 1.226 | 1.207 | −1.6 | 1.35 | 1.25 | 1.60 |
| 1/C1 | Yes | 1.163 | 1.145 | −1.5 | 2.16 | 0.94 | 1.18 |
| 1/M1 | Yes | 1.094 | 1.018 | −6.9 | 3.87 | 1.64 | 1.73 |
| 1/Y1 | Yes | 0.956 | 0.978 | 2.3 | 4.18 | 1.17 | 1.48 |
| 2/K2 | No | 1.125 | 1.029 | −8.5 | 4.43 | 3.89 | 4.05 |
| 2/C2 | No | 1.035 | 0.913 | −11.8 | 6.60 | 4.35 | 3.36 |
| 2/M2 | No | 0.996 | 0.871 | −12.6 | 6.45 | 4.80 | 3.07 |
| 2/Y2 | No | 1.017 | 0.898 | −11.7 | 3.81 | 2.27 | 1.34 |
| 2/K2 | Yes | 1.176 | 1.140 | −3.1 | 2.15 | 2.03 | 2.49 |
| 2/C2 | Yes | 1.108 | 1.048 | −5.5 | 7.61 | 3.58 | 3.76 |
| 2/M2 | Yes | 1.068 | 0.915 | −14.3 | 6.54 | 4.67 | 3.14 |
| 2/Y2 | Yes | 1.097 | 1.030 | −6.1 | 2.30 | 1.41 | 0.84 |
| 3/K3 | No | 1.194 | 1.035 | −13.3 | 6.38 | 5.40 | 5.24 |
| 3/C3 | No | 1.062 | 0.880 | −17.1 | 7.16 | 5.43 | 3.59 |
| 3/M3 | No | 1.097 | 0.949 | −13.5 | 7.08 | 4.95 | 3.27 |
| 3/Y3 | No | 1.089 | 0.930 | −14.6 | 5.13 | 2.22 | 1.71 |
| 3/K3 | Yes | 1.202 | 1.178 | −2.0 | 1.69 | 1.59 | 2.05 |
| 3/C3 | Yes | 1.131 | 1.075 | −4.9 | 4.85 | 2.36 | 2.41 |
| 3/M3 | Yes | 1.163 | 1.029 | −11.6 | 4.91 | 2.95 | 2.36 |
| 3/Y3 | Yes | 1.130 | 1.050 | −7.1 | 4.11 | 2.03 | 1.40 |

TABLE 1B
100% Cotton Woven Fabric; Heat Cured at 150° C., 3 minutes

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.153 | 1.008 | −12.6 | 6.05 | 5.09 | 4.62 |
| 1/C1 | No | 1.104 | 1.013 | −8.3 | 3.78 | 2.50 | 1.65 |
| 1/M1 | No | 0.977 | 0.898 | −8.1 | 4.10 | 1.74 | 1.65 |
| 1/Y1 | No | 1.025 | 0.902 | −12.0 | 8.26 | 1.83 | 2.59 |
| 1/K1 | Yes | 1.197 | 1.185 | −1.0 | 0.70 | 0.66 | 0.87 |
| 1/C1 | Yes | 1.131 | 1.126 | −0.4 | 1.16 | 0.72 | 0.55 |
| 1/M1 | Yes | 1.066 | 1.094 | 2.7 | 1.84 | 1.04 | 0.86 |
| 1/Y1 | Yes | 1.149 | 1.157 | 0.7 | 2.96 | 0.74 | 0.94 |
| 2/K2 | No | 1.070 | 0.864 | −19.2 | 9.06 | 7.95 | 6.54 |
| 2/C2 | No | 0.998 | 0.812 | −18.6 | 6.24 | 4.77 | 2.88 |
| 2/M2 | No | 0.956 | 0.782 | −18.2 | 8.79 | 4.64 | 3.84 |
| 2/Y2 | No | 0.965 | 0.778 | −19.3 | 10.45 | 2.65 | 3.47 |
| 2/K2 | Yes | 1.168 | 1.122 | −3.9 | 2.24 | 1.93 | 2.08 |
| 2/C2 | Yes | 1.100 | 1.063 | −3.3 | 1.45 | 0.87 | 0.73 |
| 2/M2 | Yes | 1.042 | 0.992 | −4.8 | 3.36 | 1.61 | 1.62 |
| 2/Y2 | Yes | 1.041 | 0.980 | −5.9 | 3.46 | 0.90 | 1.15 |
| 3/K3 | No | 1.107 | 0.870 | −21.5 | 11.17 | 9.70 | 7.97 |
| 3/C3 | No | 1.005 | 0.799 | −20.5 | 6.45 | 4.76 | 2.90 |
| 3/M3 | No | 1.053 | 0.783 | −25.7 | 13.21 | 7.43 | 5.49 |
| 3/Y3 | No | 1.023 | 0.688 | −32.8 | 18.39 | 4.57 | 5.96 |
| 3/K3 | Yes | 1.206 | 1.192 | −1.2 | 1.30 | 1.25 | 1.60 |
| 3/C3 | Yes | 1.114 | 1.083 | −2.7 | 1.58 | 0.66 | 0.84 |
| 3/M3 | Yes | 1.147 | 1.112 | −3.0 | 3.55 | 1.42 | 1.65 |
| 3/Y3 | Yes | 1.115 | 1.064 | −4.6 | 2.80 | 0.73 | 0.90 |

TABLE 1C
100% Cotton Woven Fabric; Uncured

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.121 | 0.798 | −28.8 | 13.59 | 11.88 | 9.13 |
| 1/C1 | No | 1.053 | 0.777 | −26.2 | 10.98 | 7.16 | 4.47 |
| 1/M1 | No | 1.010 | 0.679 | −32.8 | 14.40 | 7.49 | 5.66 |
| 1/Y1 | No | 1.092 | 0.645 | −41.0 | 26.60 | 6.18 | 8.22 |
| 1/K1 | Yes | 1.194 | 1.025 | −14.2 | 9.28 | 7.70 | 6.72 |
| 1/C1 | Yes | 1.150 | 0.995 | −13.5 | 5.24 | 3.85 | 2.17 |
| 1/M1 | Yes | 1.078 | 0.954 | −11.5 | 6.08 | 3.02 | 2.49 |
| 1/Y1 | Yes | 1.188 | 0.886 | −25.4 | 13.38 | 2.89 | 4.11 |
| 2/K2 | No | 1.053 | 0.442 | −58.1 | 31.30 | 31.10 | 18.27 |
| 2/C2 | No | 0.959 | 0.177 | −81.6 | 46.10 | 28.26 | 19.07 |
| 2/M2 | No | 0.953 | 0.263 | −72.5 | 45.68 | 27.06 | 19.32 |
| 2/Y2 | No | 0.931 | 0.115 | −87.6 | 62.60 | 22.74 | 21.12 |
| 2/K2 | Yes | 1.167 | 0.907 | −22.2 | 10.83 | 9.26 | 7.52 |
| 2/C2 | Yes | 1.078 | 0.795 | −26.3 | 10.96 | 9.18 | 4.72 |
| 2/M2 | Yes | 1.046 | 0.765 | −26.9 | 12.26 | 8.90 | 5.55 |
| 2/Y2 | Yes | 1.011 | 0.618 | −38.9 | 21.83 | 6.72 | 7.40 |
| 3/K3 | No | 1.156 | 0.559 | −51.7 | 28.80 | 27.67 | 18.05 |
| 3/C3 | No | 1.034 | 0.359 | −65.3 | 32.15 | 20.88 | 13.30 |
| 3/M3 | No | 1.040 | 0.382 | −63.3 | 35.70 | 21.68 | 15.00 |
| 3/Y3 | No | 0.988 | 0.339 | −65.7 | 43.64 | 13.53 | 14.51 |
| 3/K3 | Yes | 1.218 | 0.916 | −24.8 | 11.50 | 9.63 | 7.87 |
| 3/C3 | Yes | 1.108 | 0.824 | −25.6 | 9.75 | 8.04 | 4.17 |
| 3/M3 | Yes | 1.131 | 0.783 | −30.7 | 14.91 | 10.12 | 6.72 |
| 3/Y3 | Yes | 1.069 | 0.703 | −34.3 | 19.71 | 5.51 | 6.50 |

TABLE 2A
Gildan White 780 Cotton Knitted Fabric; LED395,
50% Energy, 1 Second after Pass 1 and Pass 2

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.201 | 0.974 | −18.9 | 8.62 | 7.19 | 6.75 |
| 1/C1 | No | 1.100 | 0.800 | −27.3 | 12.04 | 7.84 | 5.09 |
| 1/M1 | No | 1.027 | 0.794 | −22.7 | 14.87 | 5.25 | 5.67 |
| 1/Y1 | No | 1.107 | 0.925 | −16.5 | 11.49 | 3.11 | 3.69 |
| 1/K1 | Yes | 1.248 | 1.195 | −4.2 | 2.19 | 2.06 | 2.79 |
| 1/C1 | Yes | 1.146 | 1.092 | −4.7 | 6.25 | 3.01 | 2.72 |
| 1/M1 | Yes | 1.056 | 0.914 | −13.4 | 8.08 | 2.92 | 3.17 |
| 1/Y1 | Yes | 1.125 | 1.056 | −6.1 | 5.62 | 1.79 | 1.92 |

TABLE 2B
Gildan White 780 Cotton Knitted Fabric;
Heat Cured at 150° C., 3 minutes

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.140 | 0.795 | −30.3 | 15.19 | 13.35 | 10.21 |
| 1/C1 | No | 1.053 | 0.765 | −27.4 | 11.94 | 8.35 | 5.04 |
| 1/M1 | No | 1.022 | 0.743 | −27.3 | 14.13 | 7.00 | 5.70 |
| 1/Y1 | No | 1.082 | 0.714 | −34.0 | 25.46 | 6.10 | 7.96 |
| 1/K1 | Yes | 1.227 | 1.125 | −8.3 | 4.73 | 3.87 | 3.87 |
| 1/C1 | Yes | 1.159 | 1.074 | −7.4 | 3.17 | 2.17 | 1.44 |
| 1/M1 | Yes | 1.044 | 1.011 | −3.1 | 2.66 | 1.10 | 1.20 |
| 1/Y1 | Yes | 1.132 | 1.006 | −11.2 | 7.47 | 1.82 | 2.33 |

TABLE 2C
Gildan White 780 Cotton Knitted Fabric; Uncured

| | | OD | | | | | |
|---|---|---|---|---|---|---|---|
| Ink Set/ | | (Pre- | OD | | | | ΔE_{CMC} |
| Ink ID | Fixer | wash) | (5 washes) | %ΔOD | ΔE_{CIE} | ΔE₂₀₀₀ | (2:1) |
| 1/K1 | No | 1.147 | 0.667 | −41.8 | 23.13 | 21.14 | 15.20 |
| 1/C1 | No | 1.066 | 0.495 | −53.6 | 25.46 | 17.28 | 10.75 |
| 1/M1 | No | 1.009 | 0.570 | −43.5 | 28.02 | 14.97 | 11.38 |
| 1/Y1 | No | 1.071 | 0.452 | −57.8 | 47.50 | 12.75 | 14.88 |
| 1/K1 | Yes | 1.207 | 0.971 | −19.6 | 12.15 | 10.12 | 8.70 |
| 1/C1 | Yes | 1.148 | 0.875 | −23.8 | 11.77 | 7.30 | 4.80 |
| 1/M1 | Yes | 1.054 | 0.771 | −26.9 | 17.48 | 8.63 | 6.90 |
| 2/Y1 | Yes | 1.149 | 0.804 | −30.0 | 22.76 | 5.27 | 7.05 |

As can be seen in the data presented in Tables 1A-2C, acceptable optical densities prior to washing as well as washfastness durability for the heat-cured formulations outperformed the uncured printed fabric samples, both with and without the use of the fixer fluid that contained the azetidinium-containing polyamine. However, it was notable that even without the application of heat to cure the printed fabric to cause crosslinking of the crosslinkable polymeric binder, one or two seconds of high intensity UV energy applied to the printed ink compositions and with fixer fluids generate comparable washfastness data, which in some instances outperformed heat curing examples, e.g., some UV-cured fabric samples were more durable some were not as durable as the heat-cured fabric samples. This is particularly notable when comparing the %ΔOD data.

While the present technology has been described with reference to certain examples, various modifications, changes, omissions, and substitutions can be made without departing from the spirit of the disclosure. It is intended, therefore, that the disclosure be limited only by the scope of the following claims.

What is claimed is:

1. A fluid set, comprising:
a fixer fluid including a fixer vehicle and from 0.5 wt % to 12 wt % of a cationic fixing agent comprising an azetidinium-containing polyamine;
a cyan ink composition including a cyan pigment;
a magenta ink composition including a magenta pigment; and
a yellow ink composition including a yellow pigment,
wherein the cyan ink composition, the magenta ink composition, and the yellow ink composition independently include an ink vehicle and from 2 wt % to 15 wt % crosslinkable polymeric binder, and wherein the cyan ink composition, the magenta ink composition, and the yellow ink composition at 10 μm thick independently exhibit from 40% to 100% energy absorbed when exposed to a common narrow band of UV energy having a peak emission from 310 nm to 440 nm.

2. The fluid set of claim 1, wherein the fluid set further comprises a black ink composition or a gray ink composition including a black pigment.

3. The fluid set of claim 1, wherein the fluid set further comprises a secondary ink composition color selected from orange ink composition including an orange pigment, a red ink composition including a red pigment, a green ink composition including a green pigment, a violet ink composition including a violet pigment, or a blue ink composition including a blue pigment, wherein the secondary ink composition at 10 μm thick exhibits from 40% to 100% energy absorbed when exposed to the common narrow band of UV energy having a peak emission from 310 nm to 440 nm.

4. The fluid set of claim 1, wherein the crosslinkable polymeric binder is a polyurethane binder.

5. The fluid set of claim 1, wherein the crosslinkable polymeric binder is an acrylic latex binder.

6. The fluid set of claim 1, wherein the azetidinium-containing polyamine has a ratio of crosslinked or uncrosslinked azetidinium groups to amine groups of from 0.1:1 to 10:1.

7. A printing system, comprising:
an ink composition including:
an ink vehicle,
pigment, and
from 2 wt % to 15 wt % crosslinkable polymeric binder;
a fixer fluid including:
a fixer vehicle, and
from 0.5 wt % to 12 wt % of a cationic fixing agent comprising an azetidinium-containing polyamine; and
a UV energy source to emit UV energy having a peak emission from 310 nm to 440 nm.

8. The textile printing system of claim 7, wherein the system further comprises a fabric print media substrate.

9. The textile printing system of claim 7, wherein the azetidinium-containing polyamine comprises from 2 to 12 carbon atoms between individual amine groups.

10. A method of printing, comprising:
jetting a fixer fluid onto a print media substrate, wherein the fixer fluid includes a fixer vehicle and from 0.5 wt % to 12 wt % of a cationic fixing agent comprising an azetidinium-containing polyamine;
jetting an ink composition onto the print media substrate in contact with the fixer fluid, wherein the ink composition includes an ink vehicle, pigment, and from 2 wt % to 15 wt % crosslinkable polymeric binder; and
exposing the print media substrate with the fixer fluid in contact with the ink composition to UV energy having a peak emission from 310 nm to 440 nm.

11. The method of claim 10, wherein jetting the fixer fluid, jetting the ink composition, and exposing the print media substrate with the fixer fluid in contact with the ink composition are carried out sequentially.

12. The method of claim 10, wherein the cationic fixing agent and the crosslinkable polymeric binder are jetted onto the print media substrate at a weight ratio from 0.01:1 to 1:1.

13. The method of claim 10, wherein jetting is from a thermal inkjet printhead.

14. The method of claim 10, wherein the fixer fluid has a surface tension of from 21 dyne/cm to 55 dyne/cm at 25° C. and a viscosity of from 1.5 cP to 15 cP at 25° C.

15. The method of claim 14, wherein jetting an ink composition onto the print media substrate includes jetting multiple ink compositions onto the print media substrate in contact with the fixer fluid, wherein the multiple ink compositions include a cyan ink composition including a cyan pigment, a magenta ink composition including a magenta pigment, and a yellow ink composition including a yellow pigment, wherein the cyan ink composition, the magenta ink composition, and the yellow ink composition at 10 μm thick independently exhibit from 40% to 100% energy absorbed when exposed to a common narrow band of UV energy having a peak emission from 310 nm to 440 nm.
